(19) United States
(12) Patent Application Publication
(10) Pub. No.: US 2023/0291866 A1
(43) Pub. Date: Sep. 14, 2023

(54) PROJECTION DEVICE AND PROJECTION METHOD THEREOF

(71) Applicant: Coretronic Corporation, Hsin-Chu (TW)

(72) Inventors: Ku-Hui Hsu, Hsin-Chu (TW); Pen-Ning Kuo, Hsin-Chu (TW)

(73) Assignee: Coretronic Corporation, Hsin-Chu (TW)

(21) Appl. No.: 18/171,386

(22) Filed: Feb. 20, 2023

(30) Foreign Application Priority Data
Mar. 9, 2022 (CN) 202210224357.2

(51) Int. Cl. H04N 5/74; G03B 21/20

(52) U.S. Cl. CPC H04N 5/7458; G03B 21/208; G03B 21/2066

(57) ABSTRACT

A projection device, including an illumination system, a first light valve, a light modulation module, and a projection lens, is provided. The illumination system is configured to provide an illumination light beam. The first light valve is disposed on a transmission path of the illumination light beam to convert the illumination light beam into an image light beam. The light modulation module is replaceably disposed in the projection device and includes a second light valve located on the transmission path of the illumination light beam to modulate a grayscale value of the illumination light beam and reflect the illumination light beam to the first light valve. The light modulation module is located between the illumination system and the first light valve. The projection lens is disposed on a transmission path of the image light beam to project the image light beam out of the projection device.

### CROSS-REFERENCE TO RELATED APPLICATION

This application claims the priority benefit of China application serial no. 202210224357.2, filed on Mar. 9, 2022. The entirety of the above-mentioned patent application is hereby incorporated by reference herein and made a part of this specification.

### BACKGROUND

### Technical Field

The disclosure relates to an electronic device, and more particularly to a projection device and a projection method thereof.

### Description of Related Art

In terms of the response of the television sales market, displays with high dynamic range (HDR) have become increasingly dominant in recent years, and the development of HDR projectors can also enhance the products of companies to gain competitive advantages in the future. The formation of high dynamic range images is generated by the dark field design in an optical system. Local light modulation on a digital micro-mirror device for illumination is achieved through illumination modulation, so that the dark field display in the image is darker, thereby increasing contrast.

However, in practice, it is not possible with the current development technology to achieve the pixel-level alignment of the digital micro-mirror device for illumination and a digital micro-mirror device for imaging, while synchronously flipping multiple micro-mirrors on the digital micro-mirror device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection device and a projection method thereof, which can implement a high dynamic range projection application by a dual light valve structure.

Other objectives and advantages of the disclosure can be further understood from the technical features disclosed in the disclosure.

To achieve one, part, or all of the above objectives or other objectives, the disclosure provides a projection device, which includes an illumination system, a first light valve, a light modulation module, and a projection lens. The illumination system is configured to provide an illumination light beam. The first light valve is disposed on a transmission path of the illumination light beam to convert the illumination light beam into an image light beam. The light modulation module is replaceably disposed in the projection device, and the light modulation module is located between the illumination system and the first light valve. The light modulation module includes a second light valve, which is located on the transmission path of the illumination light beam. The second light valve is configured to modulate a grayscale value of the illumination light beam and reflect the illumination light beam to the first light valve. The projection lens is disposed on a transmission path of the image light beam from the first light valve and is configured to project the image light beam out of the projection device.

In order to achieve one, part, or all of the above objectives or other objectives, the disclosure further provides a projection method of a projection device, which includes the following steps. A light modulation module is disposed in the projection device, and the light modulation module is located between an illumination system and a first light valve. An illumination light beam is provided to the light modulation module by the illumination system. A grayscale value of the illumination light beam is modulated and the illumination light beam is reflected to the first light valve by a second light valve of the light modulation module. The illumination light beam is converted into an image light beam by the first light valve. The image light beam is projected out of the projection device by the projection lens.

Based on the above, the embodiments of the disclosure have at least one of the following advantages or effects. In the projection device and the projection method thereof of the disclosure, the projection device includes the illumination system, the light modulation module, the first light valve, and the projection lens. The light modulation module is a replaceable module and includes the second light valve. Therefore, when the illumination system provides the illumination light beam to the light modulation module, the grayscale value of the illumination light beam may be modulated by the second light valve of the light modulation module to generate the illumination light beam with local light modulation. Then, the illumination light beam is converted into the image light beam with high dynamic range by the first light valve. In this way, the high dynamic range projection application can be implemented by the dual light valve structure. In addition, an imaging mode may be switched to a high dynamic range image mode or a normal image mode by the replaceable light modulation module to implement the function of switching a high dynamic range image in the same projection device.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the disclosure.

FIG. 2 is another schematic diagram of the projection device of FIG. 1.

FIG. 3 is a schematic diagram of the projection device of FIG. 2 with a light modulation module replaced.

FIG. 4 is a schematic diagram of a projection device according to another embodiment of the disclosure.

FIG. 5 is a flowchart of steps of a projection method of a projection device according to an embodiment of the disclosure.

FIG. 6 is a schematic diagram of modulation of an illumination light beam and an image light beam in a projection device according to an embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the FIG.(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

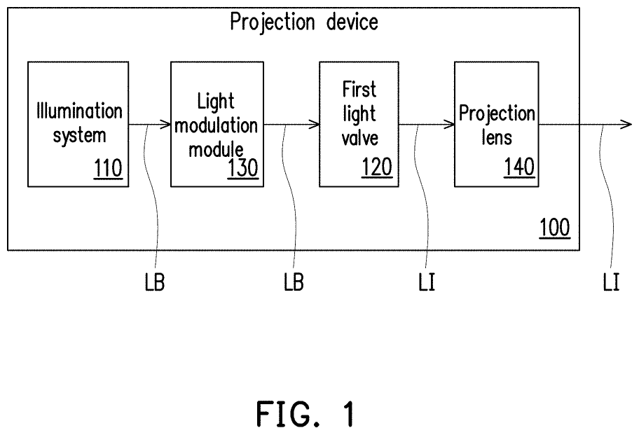

FIG. 1 is a schematic diagram of a projection device according to an embodiment of the disclosure. Please refer to FIG. 1. The embodiment provides a projection device 100, which includes an illumination system 110, a first light valve 120, a light modulation module 130, and a projection lens 140. The illumination system 110 is configured to provide an illumination light beam LB. The light modulation module 130 is located on a transmission path of the illumination light beam LB and is configured to modulate the illumination light beam LB and reflect the illumination light beam LB to the first light valve 120. The first light valve 60 is disposed on the transmission path of the illumination light beam LB and is configured to convert the illumination light beam LB into an image light beam LI. The projection lens 140 is disposed on a transmission path of the image light beam LI and is configured to project the image light beam LI out of the projection device 10 to a projection target (not shown), such as a screen or a wall.

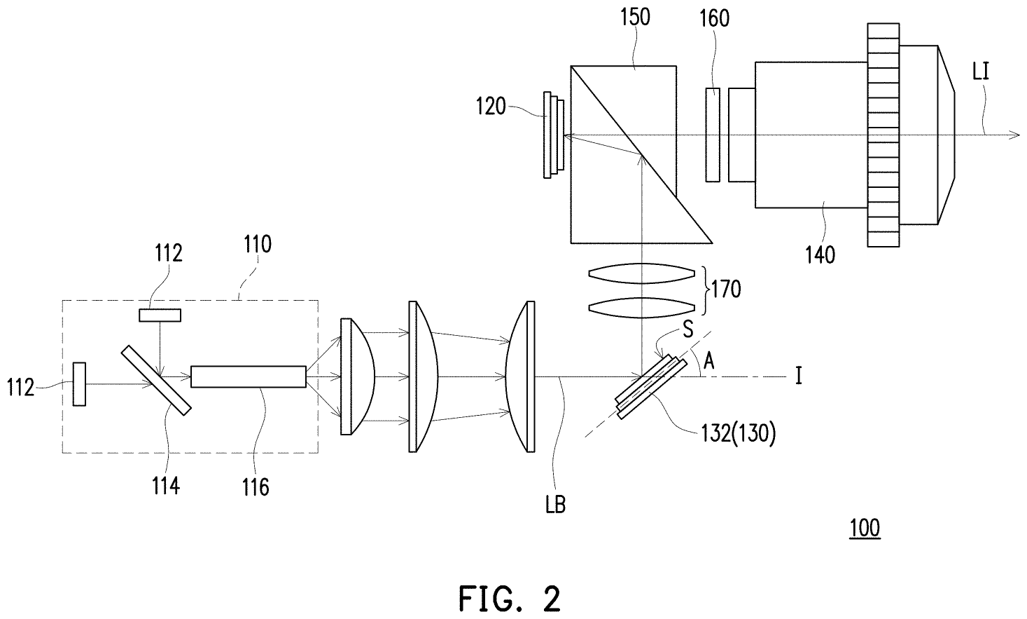

FIG. 2 is another schematic diagram of the projection device of FIG. 1. Please refer to FIG. 1 and FIG. 2. For example, in the embodiment, the illumination system 110 includes multiple light emitting elements 112, multiple light splitting and combining elements 114, and a light homogenizing element 116, and is configured to provide light with different wavelengths to form the illumination light beam LB. The light emitting element 112 is, for example, a light emitting diode (LED) or a laser diode (LD). The light splitting and combining element 114 is, for example, a beam splitter and is configured to change the transmission path of the light beams with certain wavelengths to combine light with different wavelengths. The light homogenizing element 116 is, for example, an integrating rod or a lens array (for example, a fly eye lens array) and is configured to adjust the shape of light spots of the illumination light beam LB, so that the shape of the light spots of the illumination light beam LB can match the shape (for example, rectangle) of a working region of the first light valve 120, and the light spots can have the same or similar light intensities, and homogenize the light intensity of the illumination light beam LB. However, the disclosure does not limit the type or the form of the illumination system 110 in the projection device 100. In different embodiments, the illumination system 110 may be configured with different optical elements, such as a light emitting element, a wavelength conversion element, a light homogenizing element, a filter element, and a light splitting and combining element, according to requirements, and the disclosure is not limited thereto. The detailed structures and implementations thereof can be adequately taught, suggested, and implemented from common knowledge in the art, so there will be no repetition.

The first light valve 120 is, for example, a reflective light modulator, such as a liquid crystal on silicon (LCoS) panel and a digital micro-mirror device (DMD). In some embodiments, the first light valve 120 may also be a transmissive optical modulator, such as a transparent liquid crystal panel, an electro-optical modulator, a magneto-optical modulator, and an acousto-optical modulator (AOM). The disclosure does not limit the form and the type of the first light valve 120. The detailed steps and implementations of the method of the first light valve 120 converting the illumination light beam LB into the image light beam LI can be adequately taught, suggested, and implemented from common knowledge in the art, so there will be no repetition.

The projection lens 140 includes, for example, a combination of one or more optical lenses with dioptric powers, such as various combinations of non-planar lenses, such as a biconcave lens, a biconvex lens, a concave-convex lens, a convex-concave lens, a plano-convex lens, and a plano-concave lens. In an embodiment, the projection lens 140 may further include a planar optical lens, which projects the image light beam LI from the first light valve 120 to the projection target in a reflective manner. The disclosure does not limit the form and the type of the projection lens 140.

In the embodiment, the first light valve 120 is a reflective light valve, and the projection device 100 further includes a first prism set 150 disposed on the transmission path of the image light beam LI and located between the first light valve 120 and the projection lens 140. The first prism set 150 is, for example, a total internal reflection (TIR) prism or a reverse total internal reflection (RTIR) prism. The first prism set 150 is configured to guide the illumination light beam LB to the first light valve 120 and guide the image light beam LI to the projection lens 140.

In the embodiment, the projection device 100 further includes an actuating module 160 disposed on the transmission path of the image light beam LI and located between the first light valve 120 and the projection lens 140. The actuating module 160 is, for example, a combination of an actuator and a transparent element, and is configured to allow the image light beam LI to pass through the actuating module 160 to increase resolution. When the actuator is actuated, the transparent element carried by the actuator may swing back and forth to project the image light beam LI passing through the transparent element to different positions, thereby increasing the resolution of a projected image of the projection device 100.

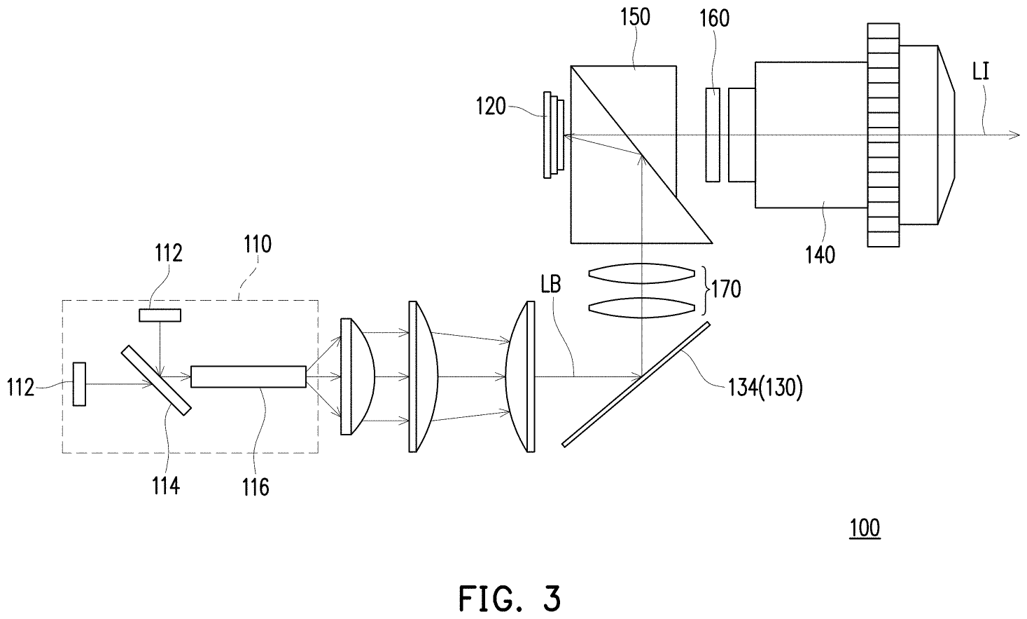

FIG. 3 is a schematic diagram of the projection device of FIG. 2 with a light modulation module replaced. Please refer to FIG. 2 and FIG. 3 at the same time. The light modulation module 130 is replaceably disposed in the projection device 100, and the disposed light modulation module 130 is located between the illumination system 110 and the first light valve 120, and is configured to modulate the illumination light beam LB. For example, in the embodiment, the light modulation module 130, for example, includes a second light valve 132 and a mirror 134.

The second light valve 132 is, for example, a reflective light modulator, such as a liquid crystal on silicon (LCoS) panel and a digital micro-mirror device (DMD). In some embodiments, the second light valve 132 may also be a transmissive optical modulator, such as a transparent liquid crystal panel, an electro-optical modulator, a magneto-optical modulator, and an acousto-optical modulator (AOM). The disclosure does not limit the form and the type of the second light valve 132.

In the configuration shown in FIG. 2, the second light valve 132 is located on the transmission path of the illumination light beam LB and is configured to modulate a grayscale value of the illumination light beam LB and reflect the illumination light beam LB to the first light valve 120. In the embodiment, the second light valve 132 is a reflective light valve. Therefore, in the configuration, the illumination light beam LB is modulated by the second light valve 132, so that the projection device 100 can provide the image light beam LI with high dynamic range (HDR). In the embodiment, an included angle A greater than 0 degrees is formed between an imaging surface S of the second light valve 132 and an optical axis I of the illumination light beam LB from the illumination system 110, so that the illumination light beam LB is reflected by the second light valve 132 to the first light valve 120. In other words, in the high dynamic range image mode, the first light valve 120 acts as an imaging light valve of the projection device 100, and the second light valve 132 acts as an illumination light valve of the projection device 100.

In the embodiment, the projection device 100 further includes a lens set 170, which is disposed on the transmission path of the illumination light beam LB and is located between the first light valve 120 and the light modulation module 130. The lens set 170 includes, for example, various combinations of non-planar lenses, such as a biconcave lens, a biconvex lens, a concave-convex lens, a convex-concave lens, a plano-convex lens, and a plano-concave lens, and is configured to blur the illumination light beam LB from the second light valve 132 to achieve blurred and homogenous imaging. However, in other embodiments, light beams emitted from the second light valve 132 may also be divided into regions and homogenously irradiated to the first light valve 120 by configuring the integrating rod array (multiple rods), and the disclosure is not limited thereto. The detailed modulation manner of the second light valve 132 will be explained in the following paragraphs. In addition, in the embodiment, the projection device 100 may optionally include a lens element, which is disposed on any light beam path and is configured to guide the illumination light beam LB emitted by the illumination system 100 to the second light valve 132, and the disclosure is not limited thereto.

On the other hand, in the configuration shown in FIG. 3, the mirror 134 is located on the transmission path of the illumination light beam LB and is configured to reflect the illumination light beam LB to the first light valve 120. Therefore, in the configuration, the illumination light beam LB is guided to the first light valve 120 for imaging by the mirror 134. The projection device 100 may also provide the image light beam LI without high dynamic range (that is, a normal image mode). In this way, the high dynamic range projection application can be implemented by the dual light valve structure. In addition, the imaging mode may be switched to the high dynamic range image mode or the normal image mode by the replaceable light modulation module to implement the function of switching a high dynamic range image in the same projection device 100.

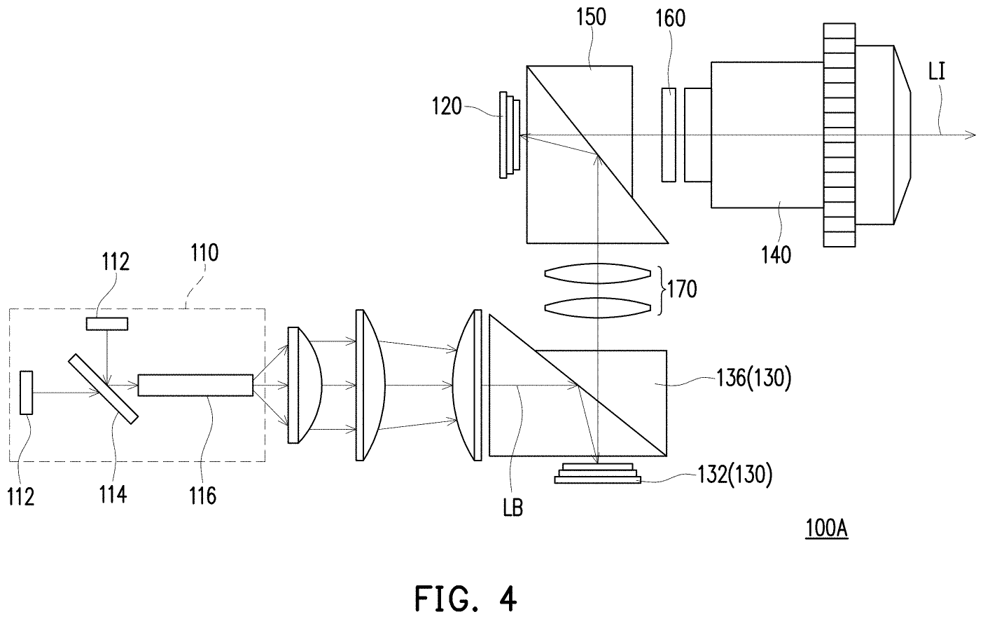

FIG. 4 is a schematic diagram of a projection device according to another embodiment of the disclosure. Please refer to FIG. 4. A projection device 100A of the embodiment is similar to the projection device 100 shown in FIG. 2. The difference between the two is that in the embodiment, a light modulation module 130A in the projection device 100A further includes a second prism set 136, which is disposed on the transmission path of the illumination light beam LB and is located between the illumination system 110 and the second light valve 132. The second prism set 136 is configured to change the transmission path of the illumination light beam LB, and the second light valve 132 is a reflective light valve. Specifically, the second light valve 132 and the second prism set 136 are disposed in combination and may be disposed together when the light modulation module 130A is replaced. Therefore, when switching from the normal image mode to the high dynamic range image mode, the second light valve 132 and the second prism set 136 are disposed on the transmission path of the illumination light beam LB at the same time.

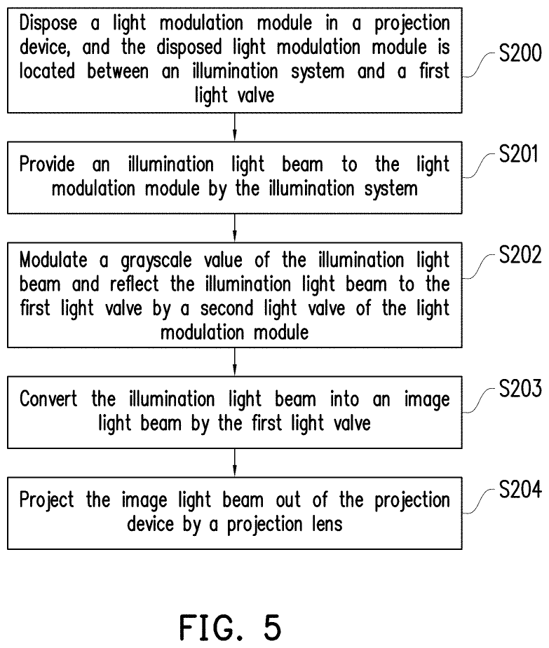

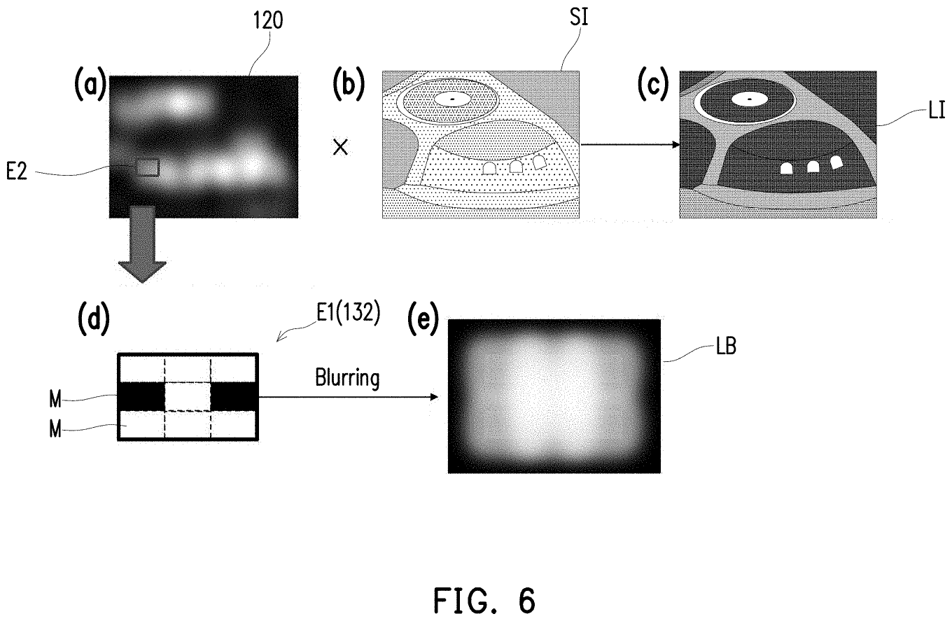

FIG. 5 is a flowchart of steps of a projection method of a projection device according to an embodiment of the disclosure. FIG. 6 is a schematic diagram of modulation of an illumination light beam and an image light beam in a projection device according to an embodiment of the disclosure. Please refer to FIG. 2, FIG. 5, and FIG. 6 at the same time. The projection method of the embodiment may be applied to at least the projection devices 100 and 100A shown in FIG. 2 and FIG. 4, and the projection device 100 in FIG. 2 is used as an example for description below. In the projection method of the embodiment, firstly, Step S200 is executed to dispose the light modulation module 130 in the projection device 100, and the disposed light modulation module 130 is located between the illumination system 110 and the first light valve 120. Specifically, in the step, the second light valve 132 in the light modulation module 130 is disposed on the transmission path of the illumination light beam LB from the illumination system 110 to complete the switching to the high dynamic range image mode.

Next, after the above step, Step S201 is executed to provide the illumination light beam LB to the light modulation module 130 by the illumination system 110. Specifically, in the step, the illumination system 110 provides the illumination light beam LB to the second light valve 132 of the light modulation module 130 for subsequent modulation.

Next, after the above step, Step S202 is executed to modulate the grayscale value of the illumination light beam LB and reflect the illumination light beam LB to the first light valve 120 by the second light valve 132 of the light modulation module 130. Specifically, in the embodiment, the second light valve 132 includes multiple modulation regions E1 (as shown in (d) of FIG. 6, for the convenience of description, (d) of FIG. 6 only shows a single modulation region E1), the first light valve 120 includes multiple sub-regions E2 (as shown in (a) of FIG. 6) corresponding to the modulation regions E1, and the illumination light beam LB reflected by the modulation regions E1 is configured to generate different grayscale values in the corresponding sub-regions E2. In other words, the imaging surface of the second light valve 132 may be divided into multiple regions, and each modulation region E1 includes multiple controllable micro-mirrors M. As shown in (d) of FIG. 6, there are nine controllable micro-mirrors M in a single modulation region E1. Here, nine micro-mirrors M are used as an example for description, but the disclosure is not limited thereto, and different numbers may be designed according to the actual situation. (e) of FIG. 6 shows a schematic diagram of the illumination light beam LB blurred by the lens set 170 after the second light valve 132 modulates the illumination light beam LB.

When the micro-mirror M is in an on state, the micro-mirror M transmits the illumination light beam LB to the first light valve 120. When the micro-mirror M is in an off state, the micro-mirror M does not transmit the illumination light beam LB to the first light valve 120. Therefore, it is possible to control the amount of reflected light in each region of the illumination light beam LB (that is, each sub-region E2 in the first light valve 120) by turning on or turning off the micro-mirrors M in each modulation region E1, thereby adjusting the grayscale value of each region of the illumination light beam LB. In other words, in Step S202, a part of the micro-mirrors M are turned on and another part of the micro-mirrors M are turned off at the same time to adjust the grayscale value of the illumination light beam LB, and the illumination light beam LB is reflected to the first light valve 120 by the micro-mirrors M in the on state, as shown in (a) of FIG. 6.

Next, after the above step, Step S203 is executed to convert the illumination light beam LB into the image light beam LI by the first light valve 120. Specifically, in the step, the modulated illumination light beam LB (as shown in (a) of FIG. 6) of the first light valve 120 is combined with original image information (as shown in (b) of FIG. 6) to generate the image light beam LI with high dynamic range, as shown in (c) of FIG. 6. Finally, after the above step, Step S204 is executed to project the image light beam LI out of the projection device 100 by the projection lens 140 to generate an image screen.

In summary, in the projection device and the projection method thereof of the disclosure, the projection device includes the illumination system, the light modulation module, the first light valve, and the projection lens. The light modulation module is a replaceable module and includes the second light valve. Therefore, when the illumination system provides the illumination light beam to the light modulation module, the grayscale value of the illumination light beam may be modulated by the second light valve of the light modulation module to generate the illumination light beam with local light modulation. Then, the illumination light beam is converted into the image light beam with high dynamic range by the first light valve. In this way, the high dynamic range projection application can be implemented by the dual light valve structure. In addition, the imaging mode may be switched to the high dynamic range image mode or the normal image mode by the replaceable light modulation module to implement the function of switching the high dynamic range image in the same projection device, which solves the issues of pixel-level alignment between two light valves and high synchronization in terms of time.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection device, comprising:
an illumination system, configured to provide an illumination light beam;
a first light valve, disposed on a transmission path of the illumination light beam and configured to convert the illumination light beam into an image light beam;
a light modulation module, replaceably disposed in the projection device, wherein the light modulation module is located between the illumination system and the first light valve, and the light modulation module comprises:
a second light valve, located on the transmission path of the illumination light beam and configured to modulate a grayscale value of the illumination light beam and reflect the illumination light beam to the first light valve; and
a projection lens, disposed on a transmission path of the image light beam from the first light valve and configured to project the image light beam out of the projection device.

2. The projection device according to claim 1, wherein the second light valve comprises a plurality of modulation regions, the first light valve comprises a plurality of sub-regions corresponding to the modulation regions, and the illumination light beam reflected by the modulation regions is configured to generate different grayscale values in the sub-regions.

3. The projection device according to claim 2, wherein each of the modulation regions comprises a plurality of micro-mirrors, each of the micro-mirrors of each of the modulation regions is set to an on state or an off state at a same time to adjust the grayscale value of the illumination light beam, and the illumination light beam is transmitted to the first light valve by the micro-mirrors in the on state.

4. The projection device according to claim 1, further comprising:
a lens set, disposed on the transmission path of the illumination light beam and located between the first light valve and the light modulation module, wherein the lens set is configured to blur the illumination light beam from the second light valve.

5. The projection device according to claim 1, wherein an included angle greater than 0 degrees is formed between an imaging surface of the second light valve of the light modulation module and an optical axis of the illumination light beam from the illumination system, so that the illumination light beam is reflected by the second light valve to the first light valve.

6. The projection device according to claim 1, wherein the illumination system further comprises a plurality of light emitting elements, a plurality of light splitting and combining elements, and a light homogenizing element.

7. The projection device according to claim 1, further comprising:
an actuating module, disposed on the transmission path of the image light beam and located between the first light valve and the projection lens, wherein the image light beam is allowed to pass through the actuating module.

8. The projection device according to claim 1, further comprising:
a first prism set, disposed on the transmission path of the image light beam and located between the first light valve and the projection lens, wherein the first prism set is configured to guide the illumination light beam to the first light valve and guide the image light beam to the projection lens, and the first light valve is a reflective light valve.

9. The projection device according to claim 1, wherein the light modulation module further comprises a second prism set disposed on the transmission path of the illumination light beam and located between the illumination system and the second light valve, the second prism set is configured to change the transmission path of the illumination light beam, and the second light valve is a reflective light valve.

10. A projection method of a projection device, wherein the projection device comprises an illumination system, a light modulation module, a first light valve, and a projection lens, and the light modulation module is a replaceable module and comprises a second light valve, the projection method comprising:
disposing the light modulation module in the projection device, wherein the light modulation module is located between the illumination system and the first light valve;
providing the illumination light beam to the light modulation module by the illumination system;
modulating a grayscale value of the illumination light beam and reflecting the illumination light beam to the first light valve by the second light valve of the light modulation module;
converting the illumination light beam into an image light beam by the first light valve; and
projecting the image light beam out of the projection device by the projection lens.

11. The projection method of the projection device according to claim 10, wherein the second light valve comprises a plurality of modulation regions, the first light valve comprises a plurality of sub-regions corresponding to the modulation regions, and the illumination light beam reflected by the modulation regions is configured to generate different grayscale values in the sub-regions.

12. The projection method of the projection device according to claim 11, wherein each of the modulation regions comprises a plurality of micro-mirrors, and the step of reflecting the illumination light beam to the first light valve by the light modulation module further comprises:
turning on a part of the micro-mirrors and turning off another part of the micro-mirrors at a same time to adjust the grayscale value of the illumination light beam; and
reflecting the illumination light beam to the first light valve by the micro-mirrors in an on state.

13. The projection method of the projection device according to claim 10, wherein the projection device comprises a lens set, and the step of reflecting the illumination light beam to the first light valve by the light modulation module further comprises:
reflecting the illumination light beam to the lens set by the second light valve of the light modulation module; and
blurring and transmitting the illumination light beam to the first light valve by the lens set.
